(19) United States
(12) Patent Application Publication
(10) Pub. No.: US 2004/0092391 A1
(43) Pub. Date: May 13, 2004

(54) Fluid bed catalyst for dehydrogenation of hydrocarbons

(76) Inventors: Andrzej Rokicki, Prospect, KY (US); Vladimir Fridman, Louisville, KY (US)

Correspondence Address: Sud-Chemie Inc., IP/Legal Department, 1600 West Hill Street, Louisville, KY, 40210, US

(21) Appl. No.: 10/290,780

(22) Filed: Nov. 8, 2002

(51) Int. Cl. B01J 23/26

(52) U.S. Cl. 502/308

(57) ABSTRACT

A fluid bed catalyst comprising an alumina carrier, chromium and zirconium is disclosed. The resultant catalyst demonstrates greater attrition resistance than prior art catalysts comprising aluminum and chromium but without a zirconium component.

### BACKGROUND

The present development relates to a fluid bed catalyst for the dehydrogenation of hydrocarbons. Specifically, the fluid bed catalyst comprises an alumina carrier, chromium and zirconium oxide. The resultant catalyst demonstrates better attrition resistance than prior art catalysts comprising aluminum and chromium but without zirconium oxide.

Catalysts are used in a variety of commercial reactions, and are typically in the form of a pellet or powder having metal active sites on the surface of an essentially chemically inert material carrier. In many processes, a chemical reactant is introduced to the catalyst through an entrance gas stream, the reactant contacts an active site on the catalyst, a chemical conversion occurs to generate one or more products, and the products are released from the catalyst active site. For commercial operations, it is desirable that the gas be passed over the catalyst at an essentially constant and rapid rate.

In the dehydrogenation process, chromia-alumina catalysts are recognized as effective catalysts. For example, U.S. Pat. No. 3,488,402 (issued to Michaels et al., and incorporated herein by reference) teaches that dehydrogenation catalysts for use in the patented process can be “alumina, magnesia, or a combination thereof, promoted with up to about 40% of an oxide of a metal” of Group 4, Group 5 or Group 6. (The terms “Group 4”, “Group 5” and “Group 6” refer to the new IUPAC format numbers for the Periodic Table of the Elements. Alternative terminology, known in the art, includes the old IUPAC labels “Group IVA,” “Group VA” and “Group VI-A”, respectively, and the Chemical Abstract Services version of numbering as “Group IVB,” “Group VB” and “Group VI-B”, respectively.) The '402 patent continues by reciting specific examples of such catalysts including “alumina promoted with about 40% of any of chromium oxide, zirconium oxide and titanium oxide”, and notes that “a particularly effective catalytic composition for dehydrogenating paraffin hydrocarbons is a two-component catalyst consisting of about 40% chromia and 60% alumina . . . ” The '402 patent, however, does not teach a three-component catalyst.

As is known in the art, the catalyst itself is not permanently altered in the chemical reaction that it catalyzes. However, over time, the catalyst efficiency can be diminished by a number of factors. Some of these factors are essentially reversible. For example, not all products of the reaction may release from the active sites resulting in contamination of the active sites and diminished performance of the catalyst. In this situation, cleaning or regenerating the catalyst bed can improve the efficiency. Alternatively, some of the factors affecting efficiency are essentially irreversible. For example, in a fluid bed, the catalyst particles can crumble or they may interact and experience surface grinding, thereby decreasing the particle size and generating “fines.” Very small particles and fines can be blown out of the system resulting in catalyst loss. Alternatively, the catalyst may agglomerate which can lead to a failure to fluidize. In each case, there is a negative impact on paraffin conversion and/or on the selectivity of the process, and the catalyst may need to be at least partially replaced. Replacing a catalyst bed is costly from a material and labor perspective. Thus, it is desirable to have a catalyst that has high attrition resistance.

Traditionally, the attrition resistance of dehydrogenation catalysts has been improved by adding silica-based materials to a catalyst composition. For example, U.S. Pat. No. 4,746,643 (issued on May 24, 1988, and assigned to Snamprogetti S.p.A. (Milan, IT) and Niimsk (Yaroslavl, SU)) teaches an aluminum oxide carrier with chromium oxide and potassium oxide on the surface. To improve the attrition resistance, the catalyst is impregnated with a solution comprising a silica compound. Alternatively, as taught in U.S. Pat. No. 5,866,737 (issued on Feb. 2, 1999, and assigned to BASF Aktiengesellschaft) a catalyst having a high attrition resistance comprises at least one oxygen-conferring metal oxide redox catalyst selected from the oxides of Bi, V, Ce, Fe, In, Ag, Cu, Co, Mn, Pb, Sn, Mo, Sb, As, Nb, U, W or mixtures thereof. The examples teach using a supported K₂O/La₂O₃/Bi₂O₃/TiO₂ catalyst. The '737 patent does not teach combining metal oxide supports in the absence of the specified oxides.

### SUMMARY OF THE INVENTION

The present development relates to a fluid bed catalyst comprising an alumina carrier, chromium and zirconium. The zirconium is most likely in a form of solid solution in alumina matrix, and when calculated as a zirconium oxide, the zirconium is present at concentrations of from about 0.1 wt % to about 15 wt %, based on the total catalyst weight, including the zirconium. In a shown embodiment, an alumina carrier that has been spray dried and calcined, is impregnated with a CrO₃ solution further comprising an alkali metal hydroxide and zirconium carbonate. The resultant catalyst demonstrates greater attrition resistance than prior art catalysts comprising aluminum and chromium but without zirconium oxide.

### DETAILED DESCRIPTION OF THE PREFERRED EMBODIMENT

The catalyst of the present invention is intended for use in a dehydrogenation process for converting C₂-C₆ hydrocarbons to olefins and/or diolefins. The catalyst composition is similar to dehydrogenation catalysts of the prior art with respect to using an aluminum oxide carrier further comprising chromium. However, the catalyst composition also includes zirconium, and the presence of zirconium improves the attrition resistance of the catalyst.

The dehydrogenation catalyst of the present invention is designed for use in a fluidized bed reactor. These reactors are well known in the art. In a fluidized bed reactor, the catalyst particles are constantly backmixed, and the bed has relatively good mass transfer, resulting in a relatively small temperature gradient across the bed during dehydrogenation and regeneration, and demonstrating good heat transfer between the fluidized bed and the existing heat exchanger surfaces.

As is known in the art, a catalyst generally has one or more active metals dispersed on or compounded with a carrier or support. The support provides a means for increasing the surface area of the catalyst. Recommended carriers for dehydrogenation catalysts include aluminum oxide, aluminas, alumina monohydrate, alumina trihydrate, alumina-silica, transition aluminas, silica, silicate, zeolites and combinations thereof. The catalyst of the present invention has a particle size of from about 20 μm to about 150 μm, a surface area of from about 30 m²/g to about 200 m²/g, a pore volume of from about 0.2 cc/g to about 1.5 cc/g, and an average pore diameter of from about 3 nm to about 30 nm. The support may be prepared by a variety of techniques that are known in the art. Optionally, the carrier may be spray-dried and calcined at about from about 1200° F. to about 1950° F.

Chromium is commonly used in dehydrogenation catalysts because of its efficiency in paraffin dehydrogenation reactions. Typically in dehydrogenation catalysts, the chromium is in the form of Cr₂O₃ that is produced from CrO₃. The chromium may also be derived from chromate or dichromate ammonia, chromium nitrate or other organic or inorganic chromium salts. The catalyst of the present invention comprises from about 10 wt % to about 30 wt % chromium, based on the total catalyst weight, including the Cr₂O₃. In a more preferred embodiment, the catalyst comprises from about 15 wt % to about 24 wt % chromium; and in a most preferred embodiment, the amount of chromium is from about 17 wt % to about 22 wt %. The chromium is added to the support in the form of a CrO₃ solution that is impregnated onto a spray-dried and calcined γ-Al₂O₃ carrier.

Dehydrogenation catalysts also commonly include at least one promoter that is added to improve selected properties of the catalyst or to modify the catalyst activity and/or selectivity. In the present invention, the catalyst comprises a zirconium cation which may be present in a variety of forms or from different types of zirconium compounds, such as, as a solid solution in Al₂O₃, as ZrO₂, as Zr hydroxide, or as a similar zirconium-containing complex. The zirconium compound, calculated as ZrO₂, comprises from about 0.1 wt % to about 15 wt % zirconium, based on the total catalyst weight, including the ZrO₂. In a more preferred embodiment, the catalyst comprises from about 0.1 wt % to about 5 wt % zirconium; and in a most preferred embodiment, the amount of zirconium is from about 0.5 wt % to about 1.5 wt %. The zirconium may be added to the catalyst in a variety of ways, as are known in the art, and in a preferred embodiment is co-impregnated with the chromium. Additional promoters, such as scandium, yttrium, lanthanum, titanium, hafnium or combinations thereof, may optionally be added to the dehydrogenation catalyst of the present invention.

The following examples illustrate and explain the present invention, but are not to be taken as limiting the present invention in any regard. Examples 1 and 3 describe the preparation of embodiments of prior art chromia-alumina catalysts without (Example 1) and with (Example 3) exposure to accelerated aging conditions. Examples 2 and 4 describe the preparation of embodiments of the present invention prepared without (Example 2) and with (Example 4) exposure to accelerated aging conditions.

### EXAMPLE 1

A dehydrogenation catalyst is prepared for comparative purposes. To prepare the catalyst, 306.1 g of the γ-Al₂O₃ carrier with LOI 1% is prepared by spray-drying of pseudo-boehmite alumina slurry. The spray-drying conditions are: concentration of solid in slurry is about 15-40%, inlet and outlet temperatures are about 650° F. and 260° F., respectively. After spray-drying, the alumina is dried at about 250° F. for about 4 hours and calcined in an air atmosphere at about 1750° F. for about 4 hours. The alumina support is then impregnated by an incipient wetness method at ambient temperature with about 80 mL aqueous mixture comprising 86.8 g CrO₃ and 1.5 g NaOH and 5.17 g KOH. The impregnated carrier is dried at about 250° F. for about 4 hours and calcined at about 1410° F. for about four hours to produce the dehydrogenation catalyst. The resulting catalyst is a dehydrogenation catalyst comprising about 17.5 wt % Cr₂O₃ on a γ-Al₂O₃ carrier.

### EXAMPLE 2

A dehydrogenation catalyst is prepared according to the present invention. The catalyst is prepared according to Example 1 except that about 6.23 g of zirconium basic carbonate is added to the CrO₃ mixture before impregnation of the carrier. The resulting catalyst is a dehydrogenation catalyst comprising about 17.5 wt % Cr₂O₃ and 0.7 wt % ZrO₂ on a γ-Al₂O₃ carrier.

### EXAMPLE 3

A dehydrogenation catalyst is prepared according to Example 1 except that the catalyst is aged in a muffle oven at about 1400-1500° F. for about 100 hours. The resulting catalyst is a dehydrogenation catalyst comprising about 17.5 wt % Cr₂O₃ on a γ-Al₂O₃ carrier.

### EXAMPLE 4

A dehydrogenation catalyst is prepared according to Example 2 except that the catalyst is aged in a muffle oven at about 1400-1500° F. for about 100 hours. The resulting catalyst is a dehydrogenation catalyst comprising about 17.5 wt % Cr₂O₃ and 0.5-1.5 wt % ZrO₂ on a γ-Al₂O₃ carrier.

Reactivity Studies: The catalysts prepared in Examples 1-4 are evaluated for activity and selectivity in the dehydrogenation of isobutane in a fluid bed reactor at reactor temperatures of about 1058° F. and about 1094° F. The fluid bed reactor diameter is about 4 cm and the catalyst volume in the reactor is about 75 cc. Before the dehydrogenation cycle, the catalyst is reduced by methane for about 4 minutes at the dehydrogenation temperature with a GHSV of about 588 h⁻¹. Dehydrogenation is conducted at atmospheric pressure with isobutane at a GHSV of about 400 h⁻¹, and a time for the dehydrogenation cycle of about 15 minutes. After dehydrogenation, the catalyst is purged by nitrogen for about 15 minutes. After the nitrogen purge, the catalyst is regenerated by air at about 1202° F. for about 30 minute at an air GHSV of about 880 h⁻¹. After the nitrogen purge and regeneration, a next cycle can be started. The activity characteristics are taken after the catalyst achieves steady performance (usually after about 15 cycles of operation). The results are presented in Table I.

Loss of Attrition Studies: The catalysts prepared in Examples 1-4 are evaluated for loss of attrition by using the Davidson Index (DI) as determined by a J Cat test. The DI correlates to a catalyst's attrition resistance, wherein the higher the value, the greater the degree of attrition and the poorer the catalyst. The J Cat test method is described in detail by S. A. Weeks and P. Dumbill in Oil & Gas Journal, Apr. 16, 1990, pages 38-40 (which is incorporated herein by reference). The results are presented in Table I.

TABLE I

| Sample Description | Ex. 1 | Ex. 2 | Ex. 3 | Ex. 4 |
|---|---|---|---|---|
| Reactor T = 1058° F. | | | | |
| C1 to C3 [wt %] | 6.2 | 6.2 | 3.7 | 3.9 |
| Isobutane Conversion [wt %] | 55.8 | 55.5 | 52.6 | 53.3 |
| Isobutylene Selectivity [wt %] | 81.8 | 81.1 | 86.2 | 85.9 |
| Isobutylene Yield [wt %] | 45.7 | 45.0 | 45.3 | 45.8 |
| Coke Yield [wt %] | 0.87 | 1.10 | 0.73 | 0.87 |
| Reactor T = 1094° F. | | | | |
| C1 to C3 [wt %] | 9.8 | 10.5 | 6.9 | 7.1 |
| Isobutane Conversion [wt %] | 62.6 | 64.2 | 58.5 | 59.2 |
| Isobutylene Selectivity [wt %] | 76.3 | 75.1 | 79.8 | 79.9 |
| Isobutylene Yield [wt %] | 47.8 | 48.2 | 46.7 | 47.3 |
| Coke Yield [wt %] | 1.81 | 1.79 | 1.84 | 1.88 |
| Loss of Attrition [ID] % | 0.3 | 0.3 | 6.1 | 1.3 |

The catalyst of the present invention is intended for use in the dehydrogenation process for converting C₂-C₆ hydrocarbons to olefins and/or diolefins. The catalyst differs from the catalysts of the prior art by requiring that the catalyst comprise zirconium thereby improving the attrition resistance of the catalyst. It is understood that the composition of the catalyst and the specific processing conditions may be varied without exceeding the scope of this development.

What is claimed is:

1. A catalyst for use in a dehydrogenation process for converting hydrocarbons to olefins and/or diolefins, said catalyst comprising:
a. a carrier, selected from the group consisting of aluminum oxide, alumina, alumina monohydrate, alumina trihydrate, transition alumina, alumina-silica, silica, silicate, zeolites and combinations thereof;
b. chromium, in the form of Cr₂O₃, at a concentration of from about 10 wt % to about 30 wt %, based on the total catalyst weight, including the Cr₂O₃; and
c. zirconium, calculated as ZrO₂, at a concentration of from about 0.1 wt % to about 15 wt % zirconium, based on the total catalyst weight, including the ZrO₂.

2. The catalyst of claim 1 wherein said carrier is γ-alumina.

3. The catalyst of claim 1 wherein said carrier has a particle size of from about 20 μm to about 150 μm, a surface area of from about 30 m²/g to about 200 m²/g, a pore volume of from about 0.2 cc/g to about 1.5 cc/g, and an average pore diameter of from about 3 nm to about 30 nm.

4. The catalyst of claim 1 wherein said carrier is a transition alumina carrier that is spray-dried and calcined at from about 1200° F. to about 1950° F.

5. The catalyst of claim 1 wherein said chromium is derived from the group consisting of CrO₃, chromate, dichromate ammonia, chromium nitrate, organic chromium salts, inorganic chromium salts, and combinations thereof.

6. The catalyst of claim 1 wherein said chromium is present at a concentration of from about 15 wt % to about 24 wt %, based on the total catalyst weight, including the Cr₂O₃.

7. The catalyst of claim 6 wherein said chromium is present at a concentration of from about 17 wt % to about 22 wt %, based on the total catalyst weight, including the Cr₂O₃.

8. The catalyst of claim 1 wherein said chromium is added to the support in the form of a CrO₃ solution that is impregnated onto a spray-dried and calcined transition alumina carrier.

9. The catalyst of claim 1 wherein said zirconium is present at a concentration of from about 0.1 wt % to about 5 wt %, based on the total catalyst weight, including the ZrO₂.

10. The catalyst of claim 9 wherein said zirconium is present at a concentration of from about 0.5 wt % to about 1.5 wt %, based on the total catalyst weight, including the ZrO₂.

11. The catalyst of claim 1 wherein said zirconium is co-impregnated with the chromium.

12. The catalyst of claim 1 further comprising at least one promoter selected from the group consisting of scandium, yttrium, lanthanum, titanium, hafnium and combinations thereof.

13. A dehydrogenation catalyst comprising:
a. a carrier, selected from the group consisting of aluminum oxide, alumina, alumina monohydrate, alumina trihydrate, transition alumina, alumina-silica, silica, silicate, zeolites and combinations thereof, and having a particle size of from about 20 μm to about 150 μm, a surface area of from about 30 m²/g to about 200 m²/g, a pore volume of from about 0.2 cc/g to about 1.5 cc/g, and an average pore diameter of from about 3 nm to about 30 nm.;
b. chromium, in the form of Cr₂O₃, at a concentration of from about 10 wt % to about 30 wt %, based on the total catalyst weight, including the Cr₂O₃, wherein said chromium is derived from the group consisting of CrO₃, chromate, dichromate ammonia, chromium nitrate, organic chromium salts, inorganic chromium salts, and combinations thereof; and
c. zirconium, calculated as ZrO₂, at a concentration of from about 0.1 wt % to about 15 wt % zirconium, based on the total catalyst weight, including the ZrO₂.

14. The catalyst of claim 13 wherein said carrier is γ-alumina.

15. The catalyst of claim 13 wherein said carrier is a transition alumina carrier that is spray-dried and calcined at from about 1200° F. to about 1950° F.

16. The catalyst of claim 13 wherein said chromium is present at a concentration of from about 17 wt % to about 22 wt %, based on the total catalyst weight, including the Cr₂O₃.

17. The catalyst of claim 13 wherein said chromium is added to the support in the form of a CrO₃ solution that is impregnated onto a spray-dried and calcined transition alumina carrier.

18. The catalyst of claim 13 wherein said zirconium is present at a concentration of from about 0.1 wt % to about 5 wt %, based on the total catalyst weight, including the ZrO₂.

19. The catalyst of claim 13 wherein said zirconium is present at a concentration of from about 0.5 wt % to about 1.5 wt %, based on the total catalyst weight, including the ZrO₂.

20. The catalyst of claim 17 wherein said zirconium is co-impregnated with the chromium.

21. The catalyst of claim 13 further comprising at least one promoter selected from the group consisting of scandium, yttrium, lanthanum, titanium, hafnium and combinations thereof.

22. A dehydrogenation catalyst comprising:
a. a carrier, selected from the group consisting of aluminum oxide, alumina, alumina monohydrate, alumina trihydrate, transition alumina, alumina-silica, silica, silicate, zeolites and combinations thereof, and having a particle size of from about 20 μm to about 150 μm, a surface area of from about 30 m²/g to about 200 m²/g, a pore volume of from about 0.2 cc/g to about 1.5 cc/g, and an average pore diameter of from about 3 nm to about 30 nm., wherein said carrier is spray-dried and calcined;
b. chromium, in the form of Cr₂O₃, at a concentration of from about 10 wt % to about 30 wt %, based on the total catalyst weight, including the Cr₂O₃, wherein said chromium is derived from the group consisting of CrO₃, chromate, dichromate ammonia, chromium nitrate, organic chromium salts, inorganic chromium salts, and combinations thereof, wherein said chromium is added to the support in the form of a CrO₃ solution that is impregnated onto the spray-dried and calcined carrier; and
c. zirconium, calculated as ZrO₂, at a concentration of from about 0.1 wt % to about 15 wt % zirconium, based on the total catalyst weight, including the ZrO₂, wherein said zirconium is co-impregnated with the chromium.

23. The catalyst of claim 22 wherein said carrier is a transition alumina carrier that is spray-dried and calcined at from about 1200° F. to about 1950° F.

24. The catalyst of claim 22 wherein said zirconium is present at a concentration of from about 0.1 wt % to about 5 wt %, based on the total catalyst weight, including the ZrO₂.

25. The catalyst of claim 24 wherein said zirconium is present at a concentration of from about 0.5 wt % to about 1.5 wt %, based on the total catalyst weight, including the ZrO₂.

26. The catalyst of claim 22 further comprising at least one promoter selected from the group consisting of scandium, yttrium, lanthanum, titanium, hafnium and combinations thereof.
